(19) United States
(12) Patent Application Publication
(10) Pub. No.: US 2026/0286164 A1
(43) Pub. Date: Sep. 24, 2026

(54) COATING COMPOSITION FOR A WIPER BLADE OF A WINDSCREEN WIPER

(71) Applicant: Valeo Systèmes d'Essuyage, Le Mesnil Saint Denis (FR)

(72) Inventors: Amélie Noel, Issoire (FR); Lucie Brossard, Issoire (FR)

(73) Assignee: Valeo Systèmes d'Essuyage, Le Mesnil Saint Denis (FR)

(21) Appl. No.: 19/469,820

(22) PCT Filed: Mar. 29, 2024
(86) PCT No.: PCT/EP2024/058780

§ 371 Date: Sep. 26, 2025

(30) Foreign Application Priority Data
Mar. 29, 2023 (FR) FR2303033

(51) Int. Cl. C09D 133/02; C09D 7/43; C09D 7/48; C09D 7/61; C09D 7/65

(52) U.S. Cl. CPC C09D 133/02; C09D 7/43; C09D 7/48; C09D 7/61; C09D 7/65

(57) ABSTRACT

Described is a coating composition for a wiper blade of a windscreen wiper. The composition is an aqueous phase composition including a resin and from 30 to 60% by weight of a solid lubricant in dispersion. The composition further includes 0.1 to 2% by weight of graphene. Also described is a method for preparing the composition, use of the composition, and a wiper blade coated with the composition.

The invention relates to a coating composition for a wiper blade for a vehicle windshield wiper, to the use of such a composition and to a process for preparing same. It also relates to a wiper blade for a windshield wiper, the wiper blade being at least partially coated with the composition.

Motor vehicles are commonly equipped with windshield wiper systems to wash and/or wipe the windshield and prevent the driver's view of their environment from being impaired. The windshield wipers of such a system are conventionally driven by arms performing an angular back-and-forth movement. These blades rub against the outer surface of the glass, for example of the windshield, and remove the water, taking it out of the driver's field of vision. In a conventional version, the wipers are produced in the form of articulated yokes that hold the wiper blade at several points. In a more recent version, known as a “flat blade”, the wipers are produced in the form of a semi-rigid assembly that holds the wiper blade in place along its entire length.

Generally speaking, a wiper blade is made of an elastically deformable material based on an elastomer supplemented with additives, in particular for improving its mechanical properties, elasticity, resistance to wear, resistance to external attack, or else for facilitating the implementation of the manufacturing process. These may for example be reinforcing fillers, plasticizers, vulcanizing agents and agents for protecting against UV radiation, oxidation, ozone and/or wear.

In the case of wiper blades for a motor vehicle windshield wiper, these blades must have characteristics enabling effective wiping of the windshield over which they move, while exhibiting sound comfort in use for the occupant of the vehicle, that is to say avoid generating sound waves or noise. However, during the use of the windshield wiper, the constant friction of the blade on the windshield causes premature wear of the blade, having the effect not only of losing wiping quality but also of generating noise.

Wear of the blade necessitates replacement of the entire windshield wiper, even though the other parts and elements of the windshield wiper are still functional. In order to increase the lifetime of a windshield wiper blade, patent U.S. Pat. No. 5,447,645 therefore describes a composition for lubricating and preserving a rubber, comprising graphite, butyl titanate and isopropanol. This composition may also include other products such as anti-UV stabilizers, a binder, etc. Such a composition, however, is highly flammable in nature, necessitating special storage conditions and therefore being poorly suited to direct use by a non-professional.

FR2977258 describes compositions useful for renovating wiper blades of windshield wipers, which compositions are aqueous compositions comprising 5% to 25% of slippery fillers, preferably graphite powder.

US2022/0220407 describes compositions for coating windshield wiper blades in an organic medium which contain up to 16% graphene, it being possible for the graphene to constitute the entire solid lubricant.

There remains a need to improve the performance of the wiper blades of windshield wipers, and in particular their resistance to wear, enabling them to last for a longer time. It is also desirable to have available coating compositions which make it possible to improve this performance and which are easy to use and which exhibit good adhesion to the wiper blade.

These and other aims are achieved by the compositions according to the present invention.

For this reason, the present invention relates to a coating composition for a wiper blade of a windshield wiper, the composition being an aqueous-phase composition comprising at least one resin and from 30% to 60% of at least one dispersed solid lubricant, the composition further comprising from 0.1% to 2%, preferably from 0.2% to 0.6%, of graphene, the percentages being given by weight relative to the total weight of the composition.

For the purposes of the invention, the term “aqueous phase” is understood to mean a composition which comprises a content of organic solvents of less than or equal to 10% by weight of the total weight of the composition. The content of organic solvents is preferably less than or equal to 5% by weight and more preferably equal to 0% by weight of the total weight of the composition.

The composition generally contains from 5% to 50% of aqueous solvent, that is to say a medium comprising water and possibly one or more hydrophilic cosolvents; such cosolvents may be, for example, of alcoholic nature, in particular glycolic esters.

The content of solid lubricant in the dispersion is adjusted so as to provide from 5% to 25% of solid lubricant in the composition. The dispersion is in aqueous phase.

The composition may also contain polymer microbeads or microparticles, such as those described in FR2925507.

The composition may also contain additives.

The invention also relates to the use of the coating composition for at least partially coating a wiper blade for a windshield wiper.

The invention further relates to a process for preparing the composition for coating a wiper blade of a windshield wiper.

The invention also relates to a wiper blade for a vehicle windshield wiper, the wiper blade being coated with said composition.

Specifically, it has been found, within the context of the present invention, that the introduction of graphene at specific concentrations into aqueous coating compositions makes it possible to increase the wear resistance of the coating, while maintaining friction and wiping quality properties of the blade. In addition, the compositions containing these contents of graphene adhere well to the wiper blade and their performance is not adversely affected by cold.

They confer the coating with a good wiping quality, the blade pushing away water correctly during wiping, without the formation of streaks or trails of water.

The composition is environmentally friendly and health-friendly by virtue of the use of materials such as graphene, and is not flammable.

The solid lubricant is understood here to mean components other than graphene.

The solid lubricant can be selected from the lubricants known to those skilled in the art. Mention may be made in particular of natural lubricants such as graphite, molybdenum disulfide, and also synthetic lubricants such as graphite fluoride, tungsten disulfide, boron nitride, tungsten, molybdenum and niobium diselenide, or titanium iodide and titanium disulfide, and also various mixtures thereof in all proportions.

Graphite and/or molybdenum disulfide are preferably used, and most particularly powdered graphite in the form of an aqueous dispersion. Preferably, the graphite has a size of less than 10 μm.

As mentioned above, the concentration of solid lubricant in aqueous dispersion is from 30% to 60% by weight.

The distribution of the graphene particles and of the solid lubricant dispersed in the composition is homogeneous.

Graphene is a two-dimensional crystalline material taking the form of a sheet. The graphene used in the compositions according to the invention may comprise from 1 to 10 sheets; it is in the form of fine particles, of from 2 to 10 μm, preferably from 5 to 10 μm.

The concentration of graphene in the coating composition is from 0.1% to 2%, particularly from 0.1% to 1%, preferably from 0.2% to 0.6%. For these concentrations, an improvement in the resistance of the coating and an improvement in the wiping quality are surprisingly observed. For higher concentrations, the dry abrasion test performance may be better and then deteriorate. The performance curve takes the form of a Gaussian curve. The improvement in resistance decreases for concentrations of greater than 2%, or even for concentrations of greater than or equal to 1% by weight.

In addition, the choice of concentrations of from 0.1% to 2%, particularly from 0.1% to 1% and preferably from 0.2% to 0.6% of graphene in the compositions confers the coating with good resistance to cold and ice. This property is important for windshield wiper blades intended to be used in cold weather, having a coating that will not be degraded, which increases the lifetime of the wiper blades. The cold resistance of the coating is degraded for very high concentrations of graphene in the composition or for compositions in an organic medium.

The concentration of graphene in the composition may thus be approximately from 0.1% to 2%, particularly from 0.1% to 1%, and in particular 0.2%, 0.3%, 0.4%, 0.5% or 0.6% by weight.

The resin may in particular be a resin in aqueous phase, comprising at least one polymer of acrylic, vinyl, styrenic or urethane type, in aqueous phase. The polymer may be a homopolymer or a copolymer. These polymers may be used alone or mixed depending on their compatibilities or the desired final properties. Advantageously, the resin contains at least one acrylic polymer in aqueous phase.

This may in particular be a dispersion or an emulsion of polymer in aqueous phase.

The resin preferably has a glass transition temperature of less than or equal to 0° C., and more preferably less than or equal to −20° C., in order to preserve the flexibility properties of the coating film at low temperature.

The amount of resin in the compositions will be adapted by those skilled in the art according to the desired properties; it is generally from 10% to 25% by weight of resin emulsion or dispersion relative to the total weight of the composition, which corresponds to approximately 30% to 50% by weight of resin relative to the weight of the dry components (excluding the solvent).

The composition according to the invention may also contain at least one additive selected from thickening agents, spreading agents, dispersing agents, antifoam agents and UV protection agents.

The UV protection agents comprise UV stabilizers and UV inhibitors.

The thickeners are preferably selected from modified celluloses and modified urethane polymers. The content is preferably less than or equal to 0.5% by weight relative to the total weight of the composition.

The spreading agent makes it possible to reduce the surface energy of the composition. It may in particular be selected from silicone surfactants, such as dimethylsiloxane-modified polyethers.

The dispersing agents aim to ensure better dispersion of the particles, such as the particles of glass and of solid lubricant. The dispersing agent is in particular a water-soluble polymeric agent; preferably, the polymeric dispersing agent comprises an ionic form of the polymer or copolymer used as resin. By way of example, a polyacrylate will preferentially be used when the resin is a polyacrylic resin.

The polymer microbeads, when they are present in the compositions, may be constituted of a polymer which may be a homopolymer or a copolymer. The polymer of the microparticles may in particular be selected from polymers based on acrylates, on diallyl phthalates, on epoxy units, vinyl acetate-ethylene, on urea-formaldehyde, on phenols, on amide (such as for example nylon), on carbonate, on fluoropolymers (such as for example polytetrafluoroethylene), on organosiloxanes, on unsaturated esters, on polyethylene, on ethylene terephthalate, on imide, on amide-imide, on propylene, on styrene, on sulfone, on ether sulfone, on urethane, on vinyl chloride. These polymers may be used alone or mixed depending on their compatibilities or the desired final properties. The polymer of the microparticles is preferably a hydrophobic polymer, and resistant to oxygen-containing solvents. It may in particular be selected from polymers based on acrylates, on amide (such as for example nylon), on carbonate, on fluoropolymers, on organosiloxanes, on styrene. The polymer is preferably selected from silicones, such as for example polyorganosiloxanes. Polymethylsilsesquioxane is preferentially used. The polymer microparticles are introduced into the dispersion in an amount capable of producing a dispersion of the microspheres.

The composition should be homogeneous in order to facilitate its subsequent application to the wiper blade. The homogeneity can be assessed by the uniformity of the distribution of the graphene particles in the resin, such that at any point in the mixture there is no appearance of overrepresentation or underrepresentation of the particles, at least macroscopically. Those skilled in the art will know how to recognize whether the distribution is homogeneous either with the naked eye or microscopically.

The invention therefore also relates to a process for preparing a coating composition as as defined in the present description, the process comprising the following steps:
a) preparing a dispersion of a solid lubricant in aqueous phase,
b) introducing graphene particles into the dispersion obtained in step a, in order to obtain a dispersion of the particles and the solid lubricant, and
c) adding at least one resin in aqueous phase to the dispersion obtained in step b.

In particular, a dispersion of a solid lubricant such as a graphite dispersion is prepared in a first step, and is then mixed with powdered graphene.

According to a variant of the invention, a ready-to-use and available dispersion of a lubricant is used. It is understood that step a also encompasses the case where such a ready-to-use dispersion is used.

According to one of the embodiments of the invention, the graphene is introduced in the form of a dry powder.

According to another embodiment of the invention, the graphene is introduced in the form of a suspension in an aqueous medium. The concentration of graphene in the suspension will be adapted so as to obtain the final graphene concentration defined above. Suspensions comprising 4% by weight of graphene are for example used; in this case, the amount of suspension is in particular from 2.5% to 25%.

A dispersion of resin, for example acrylic resin, in aqueous phase is then added to the previous mixture.

Any additives are added, if required, after step c.

The solvent(s) are also added after this step c. Said solvent(s) are in particular water and optionally one or more cosolvents such as glycol ethers, such as for example 2-butoxyethanol.

Where appropriate, polymer microparticles are introduced in step c, in a mixture with the resin in aqueous phase. The process is known to those skilled in the art from patent FR2925507.

The contents of the various constituents are as indicated above.

The invention also relates to the use of a coating composition as defined in the present text, or capable of being obtained by the process described above, for at least partially coating a wiper blade for a windshield wiper.

The composition may for example be applied directly to the wiper blade or to a profiled rubber strip which is then recut into two or three parts in order to obtain the wiper blade. The coating composition is applied by dipping the wiper blade or profiled rubber strip into the composition, by spraying the composition onto the wiper blade or profiled rubber strip, or by coating the wiper blade or profiled rubber strip with the composition. The wiper blade or the profiled rubber strip is then dried. In the case of the rubber strip, the latter is lastly recut into two or three parts in order to obtain the wiper blades.

The application step may be preceded by a step of preheating and baking of the coating, in particular in an infrared oven or convection oven.

The thickness of the coating layer is between 1 and 10 μm, preferably between 2 and 6 μm, and more preferentially between 3 and 5 μm.

The invention also relates to a windshield wiper blade to which the coating composition has been applied. The blade is coated with a composition comprising at least solid lubricants, graphene and resin, as defined above, but in which the solvent has been evaporated.

### BRIEF DESCRIPTION OF THE FIGURES

The invention will be better understood on reading the following description given solely by way of example and made with reference to the appended drawings in which:

FIG. 1 shows a wiper blade of a windshield wiper in accordance with the invention.

FIG. 2 shows the percentage improvement in coating composition resistance as a function of the percentage of graphene in the formulation.

FIG. 3 shows the results of an aqueous coating with a low percentage of graphene before and after a window washing liquid adhesion test, and also the result of a ice adhesion test.

FIG. 4 shows the dry abrasion results obtained from 3 compositions: reference (without graphene), according to the invention (0.6% graphene) or containing 13.5% graphene.

According to FIG. 1, the wiper blade 1 of a windshield wiper in accordance with the invention has an elongated shape and is intended to be carried by a wiper body (not shown). The blade 1 comprises a lip 3 and a heel 5 which are connected by a hinge 7. The assembly of lip 3, heel 5 and hinge 7 forms a base body of the blade 1.

The heel 5 allows the blade 1 to be hooked into the wiper body. The lip 3 is intended to be in contact with the outer surface of a window, such as a windshield, for the purpose of wiping it.

The hinge 7 is formed by a thin strip of material which gives the blade a certain flexibility and allows it to tilt when the direction of movement of the wiper is changed, in other words, the lip tilts back and forth.

The blade 1 is obtained by a conventional manufacturing process known to those skilled in the art.

Advantageously, at least part of the blade 1 is coated with the coating composition as described above; in particular, the base body of the blade is coated with this composition. It is thus possible to envisage embodiments in which, for example:
only the lip 3 is coated with the composition,
all of the blade 1 is coated with the composition.

### Example 1: Composition Preparation

The following compositions are prepared:

TABLE 1

| | Reference 1 | A1 | B1 | Reference 2 | A2 | B2 | C2 | D2 |
|---|---|---|---|---|---|---|---|---|
| Resin(s) | 17.8 | 17.8 | 17.7 | 24.5 | 24.5 | 24.4 | 24.1 | 23.3 |
| Lubricant | 57.4 | 57.3 | 57.1 | 34.1 | 34 | 33.9 | 33.4 | 32.4 |
| filler(s) | | | | | | | | |
| Polymer | — | — | — | 3.3 | 3.3 | 3.3 | 3.3 | 3.2 |
| particles | | | | | | | | |
| Additive(s) | 1.1 | 1.1 | 1.1 | 1.3 | 1.3 | 1.3 | 1.3 | 1.2 |
| Solvent(s) | 23.7 | 23.6 | 23.5 | 36.8 | 36.7 | 36.5 | 35.9 | 34.9 |
| Graphene | 0 | 0.2 | 0.6 | 0 | 0.2 | 0.6 | 2 | 5 |
| Lubricant | 57.4 | 57.3 | 57.1 | 34.1 | 34 | 33.9 | 33.4 | 32.4 |
| filler(s) | | | | | | | | |

### The Compositions are Prepared as Follows:

the dispersion of lubricants is ready-to-use or manufactured, preferably ready-to-use;
added to this dispersion of lubricant is the resin which is for example additivated with spreading agent and antifoam agent (based on mineral oils, polymers or silicone agents) in an amount of 1% to 1.5% by weight.

### Example 2

The properties of improvement in the resistance, adhesion of the coating to the blade and the performance in the dry abrasion test are evaluated for the compositions of example 1. The results are presented in table 2 below:

TABLE 2

| | Reference 1 | A1 | B1 | Reference 2 | A2 | B2 | C2 | D2 |
|---|---|---|---|---|---|---|---|---|
| Adhesion test | Compliant | Compliant | Compliant | Compliant | Compliant | Compliant | Compliant | Compliant |
| Dry abrasion <0.5 | 0.06 | 0.06 | 0.05 | — | — | — | — | — |
| mm3 | | | | | | | | |
| Improvement in | — | +6% | +22% | — | +24% | +26% | +13% | +12% |
| the resistance of | | | | | | | | |
| the coating | | | | | | | | |

Dry abrasion test: the wear resistance performance is measured by a dry abrasion test with different coating compositions.

Coated blades are positioned so as to cause them to slide over a smooth glass surface subjected to a compressive load (here 15 N/m) for a given number of cycles (here 43 200 cycles). After a given number of cycles, the deposition of rubber on the glass and the wear of the blade are evaluated.

Adhesion test: the hold of the various coating formulations on the rubber is evaluated.

The adhesion test consists in performing back and forth movements over the coated windshield wiper blade using a paper soaked in alcohol-based window washing liquid and then in observing and rating the surface of the coating using an internal grid.

Resistance test: comparative test between different coatings that can be produced on a given rubber. The resistance of the coating is measured as follows:

The coated blades are positioned so as to cause them to slide over a smooth glass surface to which a dust-simulating coating has been applied. They are subjected to a compression load (here 15 N/m) for a determined number of cycles (here 10 cycles). The observation of the wear of the coating is observed and measured via a video microscope.

The presence of graphene in the composition increases the resistance of the coating.

It has no negative impact on the other important criteria such as dry abrasion, friction or adhesion.

### Example 3: Abrasion Resistance Test

The abrasion resistance and stiffness properties are evaluated for a blade coated with coating compositions in which the amount of graphene is varied.

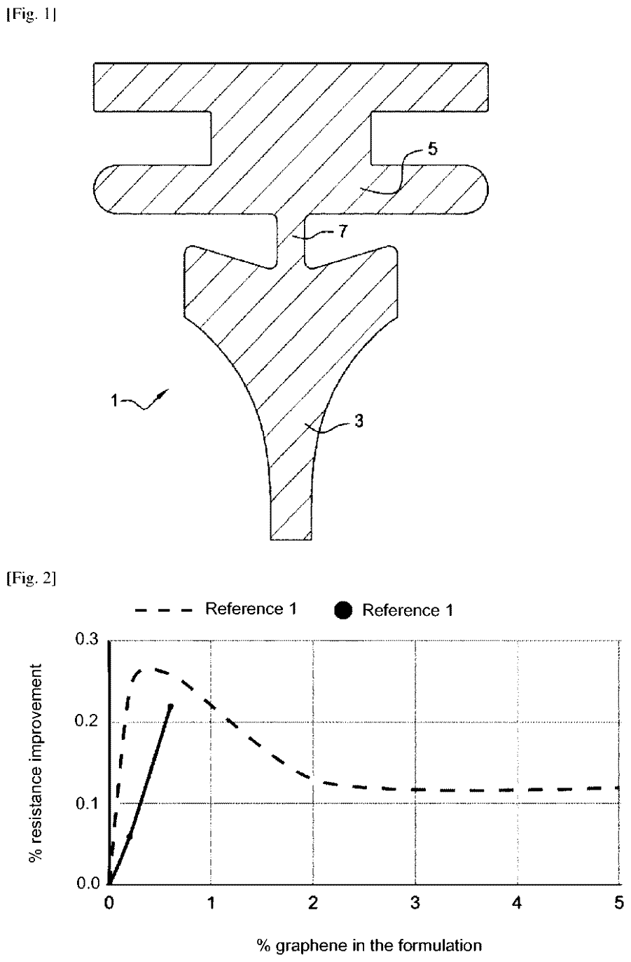

The results are shown in FIG. 2.

### Example 4: Wiping Quality

Coated blades are evaluated under real use conditions, that is to say on a vehicle windshield. The evaluation of defects of streak, haze, noise, etc., type are evaluated on a scale from 1 to 10, with 10 being the best.

The results are shown in the following table.

TABLE 3

| | Reference 1 | A1 | B1 |
|---|---|---|---|
| Upward direction | 6.6 | 7.0 | 7.0 |
| Downward direction | 8.5 | 8.5 | 8.8 |
| Average | 7.5 | 7.8 | 7.9 |

An improvement in the wiping quality is observed with the addition of graphene.

### Example 5: Cold Resistance of the Coatings

A trickle of water is applied along the lip of the rubber blade coated with the composition containing graphene, in the parked position, placed at −20° C. The blade with ice is then detached dry. The observation is carried out on the residual ice and on the rubber blade itself.

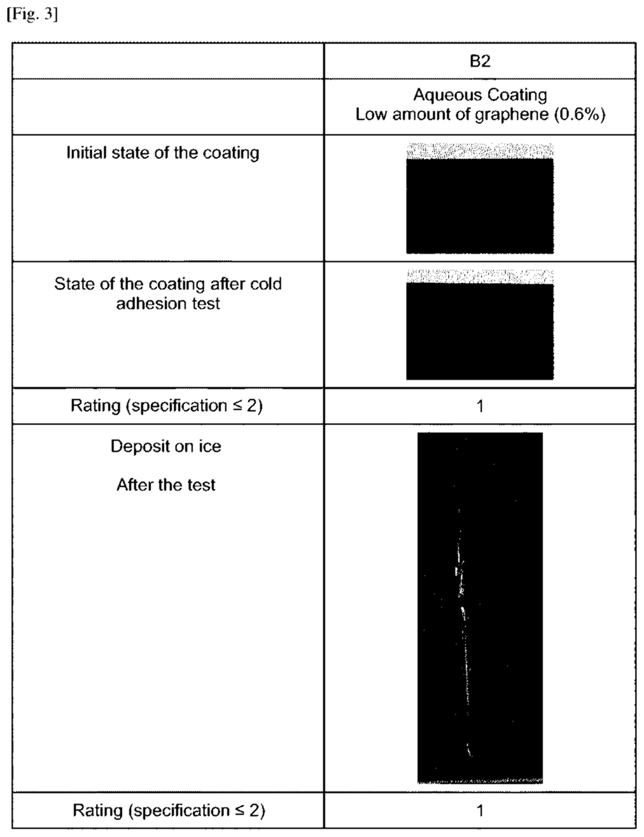

For a blade covered with a composition containing an initial graphene concentration of 0.6% according to the invention, no tearing off of the coating is observed, and the surface of the blade is intact. There is no coating deposit on the ice. The results are shown in FIG. 3.

### Example 6: Comparative Dry Abrasion Test

The dry abrasion test is carried out on a blade treated with a reference formulation not containing any graphene, a formulation containing graphene according to the invention, and on a blade treated with a formulation containing graphene at a concentration higher than that of the invention.

The compositions are prepared as described in example 1.

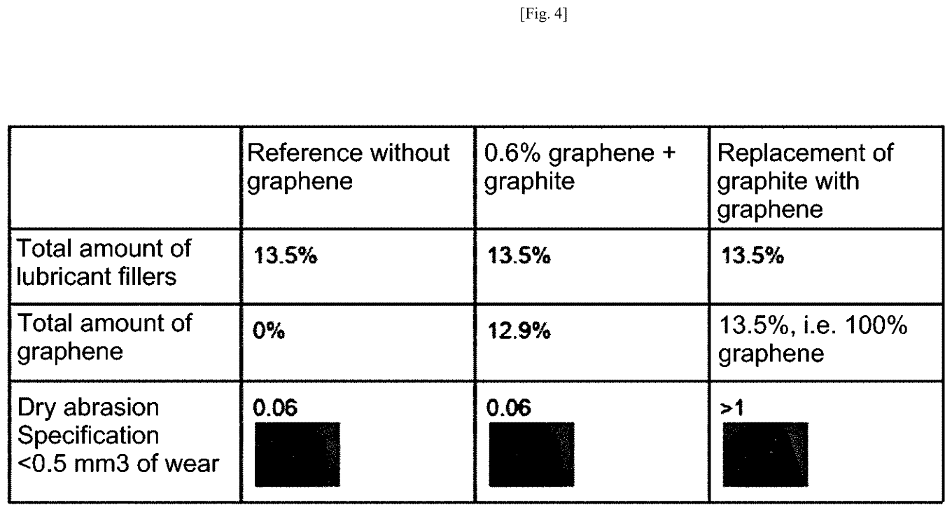

The results are presented in FIG. 4.

A degradation in the performance is observed for the coating composition containing a high concentration of graphene. The composition according to the invention does not change the result and therefore does not alter the wear resistance of the composition.

1. A coating composition for a wiper blade of a windshield wiper, the composition being an aqueous-phase composition comprising:
at least one resin;
30% to 60% by weight of a dispersion comprising at least one solid lubricant; and the
0.1% to 2% by weight of graphene,
wherein the at least one solid lubricant is different from graphene, and
wherein weight percentages are relative to a total weight of the composition.

2. The coating composition as claimed in claim 1, comprising 5% to 25% by weight of the at least one solid lubricant.

3. The coating composition as claimed in claim 1, wherein the at least one solid lubricant is selected from graphite particles and molybdenum disulfide particles.

4. The composition as claimed in claim 1, wherein the at least one resin is an acrylic, vinyl, styrenic, and/or urethane polymer, in aqueous phase.

5. The coating composition as claimed in claim 1, comprising 10% to 25% by weight of resin emulsion or dispersion relative to the total weight of the composition.

6. The coating composition as claimed in claim 1, further comprising at least one additive selected from thickening agents, spreading agents, dispersing agents, antifoam agents, and UV protection agents.

7. The coating composition as claimed in claim 1, further comprising polymer microbeads.

8. The coating composition as claimed in claim 1, comprising 0.2% to 0.6% by weight of graphene.

9. A process for preparing a coating composition as claimed in claim 1 comprising:
a) preparing the dispersion of the at least one solid lubricant in aqueous phase;
b) introducing graphene particles into the dispersion obtained in step a, in order to obtain a dispersion of the particles and the at least one solid lubricant; and
c) adding at least one resin in aqueous phase to the dispersion obtained in step b.

10. The process as claimed in claim 9, wherein in step b), the graphene is introduced in the form of a suspension in aqueous medium.

11. The process as claimed in claim 9, further comprising adding at least one additive and/or a solvent after step c.

12. A use of the composition as claimed in claim 1, for at least partially coating a wiper blade for a windshield wiper.

13. A wiper blade for a windshield wiper, the wiper blade being at least partially coated with a composition as claimed in claim 1.
